(19) United States
(12) Patent Application Publication
(10) Pub. No.: US 2024/0303049 A1
(43) Pub. Date: Sep. 12, 2024

(54) SYSTEM AND METHOD FOR REFLECTION-BASED INTEGRATED CODE AND DESIGN EDITING

(71) Applicant: Wix.com Ltd., Tel Aviv (IL)

(72) Inventors: Nadav ABRAHAMI, Tel Aviv (IL); Daniel van den Eijkel, Berlin (DE)

(21) Appl. No.: 18/602,121

(22) Filed: Mar. 12, 2024

Related U.S. Application Data
(60) Provisional application No. 63/489,761, filed on Mar. 12, 2023.

(51) Int. Cl. G06F 8/34; G06F 8/33; G06F 8/41

(52) U.S. Cl. CPC G06F 8/34; G06F 8/33; G06F 8/427

(57) ABSTRACT

A visual code editor (VCE) includes a transformer to receive and transform incoming code to be used for an application being built using the VCE, the transformer to ensure compatibility with other code for the application and to add safe mode wrapping to isolate representation of individual components to localize errors, and to convert the transformed code into an Abstract Syntax Tree (AST) representation having nodes with associated IDs, a UI mirrorer to display the transformed code together with a visual display of AST representation of the transformed code, where said visual display includes a localized representation of errors accordingly, an AST handler to convert the AST representation into a simplified AST representation for further editing of the visual display, and where the AST handler updates the transformed code according to edits to the visual display and updates the visual display according to edits to the transformed code.

### CROSS REFERENCE TO RELATED APPLICATIONS

This application claims priority from U.S. Provisional Patent Application No. 63/489,761, filed Mar. 12, 2023, which is incorporated herein by reference.

### FIELD OF THE INVENTION

The present invention relates to integrated development environments generally and to editing in particular.

### BACKGROUND OF THE INVENTION

Integrated development environments (IDEs) are code editing systems used by professionals and novices alike to create applications, components, and websites. They consolidate the basic tools required to write and test software. Development tools often include text editors, code libraries, compilers, and test platforms. IDEs can be used to edit all types of code or software.

In today's development process for web applications, the graphical user interface (GUI) of the application is typically represented by code. This code then runs on servers and within the user GUI to create the HTML for the application and update it.

IDEs that enable the editing of code are used across the industry. These IDEs support many extensions and additions that aid the user in creating, updating, and directing the code to become the intended application as planned.

In the programming industry, certain code dynamically generates user interface (UI) elements during runtime through definitions like methods, data, and classes. This dynamically generated code can be managed as plain text, which allows for traditional text-based editing and understanding, or as visual elements, enabling a graphical representation of the code's impact on the UI.

### SUMMARY OF THE PRESENT INVENTION

There is therefore provided, in accordance with a preferred embodiment of the present invention, a visual code editor (VCE). The VCE includes a transformer to receive and transform incoming code to be used for an application being built using the VCE, the transformer to ensure compatibility with other code for the application and to add safe mode wrapping to the incoming code to isolate representation of individual components to localize errors, and to convert the transformed code into an Abstract Syntax Tree (AST) representation having nodes with associated IDs, a UI mirrorer to display the transformed code together with a visual display of AST representation of the transformed code, where the visual display includes a localized representation of errors accordingly, an AST handler to convert the AST representation into a simplified AST representation for further editing of the visual display, and where the AST handler updates the transformed code according to edits to the visual display and updates the visual display according to edits to the transformed code.

Moreover, in accordance with a preferred embodiment of the present invention, the VCE further includes a runner to compile, run, and render the AST representation for the visual display by the UI mirrorer, a runtime logger to gather a log of statistics and values from the runner, an artificial intelligence (AI)/machine learning (ML) engine to at least analyze output of the runtime logger and designer editing history using artificial intelligence and machine learning techniques to provide recommendations to the AST handler, and a database to store at least output of the runtime logger and the designer editing history.

Further, in accordance with a preferred embodiment of the present invention, the transformer includes a safemode transformer to add safe mode capabilities to capture the errors and to prevent error propagation during rendering by catching syntax and specific wrapping code, and an AST creator to create the AST representation of the transformed code for the visual display.

Still further, in accordance with a preferred embodiment of the present invention, the safe mode capabilities include prevention of at least one of: infinite rendering, infinite looping and infinite recursion of the transformed code.

Additionally, in accordance with a preferred embodiment of the present invention, the UI mirrorer is configured to integrate with plug-ins to support at least one of: mobile and 3D environments.

Moreover, in accordance with a preferred embodiment of the present invention, the AST handler includes a SimpleASTnode converter to convert the nodes of the AST representation to the simplified AST representation, a properties handler to handle changes to component properties of components represented by the simplified AST representation, a debugger/tester to debug the transformed code using presented visual hints, a node comparer and synchronizer to keep track of edits to the simplified AST representation by monitoring changes to the associated IDs, an AST updater to update the AST representation according to edits to the simplified AST representation, and a code updater to update the transformed code according to edits to the simplified AST representation.

Further, in accordance with a preferred embodiment of the present invention, the UI mirrorer presents an interface (UI) including at least one of: an element panel, a style panel, the display of the transformed code and a visual representation of the transformed code.

Still further, in accordance with a preferred embodiment of the present invention, the UI mirrorer highlights the display of the errors without disrupting an editing session.

Additionally, in accordance with a preferred embodiment of the present invention, incoming code is at least one of: Typescript and JSON and the transformed code is JavaScript.

There is therefore provided, in accordance with a preferred embodiment of the present invention, a method for a visual code editor (VCE). The method includes receiving incoming code to be used for an application being built using the VCE, transforming the incoming code to ensure compatibility with other code for the application, adding safe mode wrapping to isolate representation of individual components of the incoming code to localize errors, converting the transformed code into an Abstract Syntax Tree (AST) representation having nodes with associated IDs, displaying the transformed code together with a visual display of AST representation of the transformed code where the visual display includes a localized representation of errors accordingly, converting the AST representation into a simplified AST representation for further editing of the visual display, and where the converting also updates the transformed code according to edits to the visual display and updates the visual display according to edits to the transformed code.

Moreover, in accordance with a preferred embodiment of the present invention, the method includes compiling, running and rendering the AST representation for the display by the displaying, gathering a log of statistics and values from the compiling, running and rendering, at least analyzing output of the gathering and designer editing history using artificial intelligence and machine learning techniques to provide recommendations for the converting, and storing in a database at least output of the gathering and the designer editing history.

Further, in accordance with a preferred embodiment of the present invention, the transforming, adding safe mode wrapping and converting includes adding safe mode capabilities to capture the errors and to prevent error propagation during rendering by catching syntax and specific wrapping code, and creating the AST representation of the transformed code for the visual display.

Still further, in accordance with a preferred embodiment of the present invention, the safe mode capabilities include prevention of at least one of: infinite rendering, infinite looping and infinite recursion of the transformed code.

Additionally, in accordance with a preferred embodiment of the present invention, the displaying is configured to integrate with plug-ins to support at least one of: mobile and 3D environments.

Moreover, in accordance with a preferred embodiment of the present invention, the converting the AST representation includes converting the nodes of the AST representation to the simplified AST representation, handling changes to component properties of components represented by the simplified AST representation, debugging the transformed code using presented visual hints, keeping track of edits to the simplified AST representation by monitoring changes to the associated IDs, updating the AST representation according to edits to the simplified AST representation, and updating the transformed code according to edits to the simplified AST representation.

Further, in accordance with a preferred embodiment of the present invention, the displaying presents an interface (UI) including at least one of: an element panel, a style panel, the display of the transformed code and a visual representation of the transformed code.

Still further, in accordance with a preferred embodiment of the present invention, displaying highlights the display of the errors without disrupting an editing session.

Additionally, in accordance with a preferred embodiment of the present invention, the incoming code is at least one of: Typescript and JSON and the transformed code is JavaScript.

There is therefore provided, in accordance with a preferred embodiment of the present invention, a system for processing code, the system includes a safe mode transformer to wrap the code to facilitate error isolation and debugging, an AST creator to assign nodes and node IDs to the wrapped code into an intermediary representation, an AST handler to convert the intermediary representation into a visually editable display; and an artificial intelligence (AI)/machine learning (ML) engine to assign consistent identifiers to code nodes for the intermediary representation to ensure a stable connection between the wrapped code and the visually editable display.

Moreover, in accordance with a preferred embodiment of the present invention, the AL/ML engine utilizes learning models trained on historical code editing patterns to improve accuracy of node identifier assignments over time.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic representation of a visual code editor display showing panels for both visual editing display and code editing display, constructed and operative in accordance with an embodiment of the present invention;

FIG. 2 is a schematic illustration of the elements of the visual code editor of FIG. 1, constructed and operative in accordance with an embodiment of the present invention;

FIG. 3 is a schematic illustration of the flow of functionality for the visual code editor of FIG. 1, constructed and operative in accordance with an embodiment of the present invention;

FIG. 4 is a schematic illustration of an editing interface showing a display error for the visual code editor of FIG. 1, constructed and operative in accordance with an embodiment of the present invention;

FIGS. 5A and 5B1-5 are examples of programming code for the wrapping and injection of metadata by the transformer of FIG. 2, constructed and operative in accordance with an embodiment of the present invention;

FIG. 6 is a schematic illustration of an editing interface for the visual code editor of FIG. 1, constructed and operative in accordance with an embodiment of the present invention;

FIG. 7 is a flowchart of the process of using the style panel of FIG. 6, constructed and operative in accordance with an embodiment of the present invention;

FIG. 8 is a schematic illustration of the elements of the AST handler of FIG. 2, constructed and operative in accordance with an embodiment of the present invention; and

FIG. 9 is a schematic illustration of example implementation of an integration cycle showing modifications to a visual UI element, constructed and operative in accordance with an embodiment of the present invention;

FIGS. 10A, 10B1-10 and 10C are examples of programming code for the implementation of the integration cycle of FIG. 9, constructed and operative in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that although the developers or software engineers work directly with code, website designers typically use a visual representation of components to build their site. Editing only the visual version may be restrictive and editing the code version may be slow and tedious requiring knowledge and experience in programming. It is much easier and less time-consuming to edit a visual element when it is displayed in its visual presentation than to edit it as text in the code file.

Applicant has further realized that code developed outside the IDE or within the IDE by a different developer and integrated within an existing system may run into compilation issues due to small errors/typos/incorrect parameters that may cause the display of a website page to crash or be displayed incorrectly.

Applicant has realized that these issued may be overcome by a visual code editor (VCE) that can enable the integration of code not necessarily compatible with other code within the same system. Integration may include a transformation of code suitable for use for editing and display. The transformation of code may include a safe mode application that maintains the coupling of code and design at runtime even when the code is temporarily “broken.”

Furthermore, the VCE may allow visual editing of GUI components as well as text editing of the code and be able to “toggle” or “mirror” though different views of visual editing vs code editing. An edit in a visual view, can update the code. An edit to the actual code can update the visual representation. This keeps the code synchronized with GUI design changes and vice versa. For example, when the code is “broken,” the error is rendered on the displayed UI and the error can be easily localized. The relationship may be maintained by injecting special editing-related metadata to the code, which can be used in runtime as described in more detail herein below.

The VCE may provide visualization of the components using a display that is derived from the actual displayed version of the components (and not necessarily from a limited “edit time version” or other limited versions of the component) requiring an infrastructure that supports precise rendering (including mid-editing rendering) of such components. The visualized components may also include components that do not have direct visual representation (e.g., components that represent background activity, associated code, non-display functionality, framework elements, network elements, etc.).

The VCE may also provide functionality such as setting of debugging breakpoints, single stepping and other development activities associated with the rendering cycle (including rendering and transformation done as part of an underlying framework and/or the browser itself). For example, a developer using the VCE may set a breakpoint on region change or color change (or other rendering related events not necessarily associated with specific components) or may step through rendering changes in the viewed application.

The general editing stage display for website design is typically not statically generated, but rather uses a display generated from an actual version of the code. Thus, the components visually displayed in the editing stage are the finalized version and not just a preview or a version from runtime modes. By transforming the designer code and then running it, the VCE could collect information about the code that would be impossible to do using static analysis. This information may be used to provide a better user experience for designers than that provided by traditional IDEs that only statically analyze the code. For example, components can be rendered which have varying or multiple configurations (e.g., depending on externally provided information).

This requires the VCE to have the option of running a subset (or a section or the entire) edited code. Thus, the VCE provides the capability to return to specific code sections, and re-run (or continue running) them after they have been edited.

This may include providing replacement (edited) subsections of the code being run, as well as providing the context and parameters required for such running, and handling side effects of the code's operation.

As discussed herein above, code developed outside the pertinent system may need to be “transformed” accordingly order to compile and run accordingly.

It will be appreciated that in some embodiments, the original code (e.g., TypeScript) may pass through multiple conversion or translation changes (e.g., through conversion to JavaScript), so the matching process supports matching through multiple language transformations. It will be further appreciated that the languages mentioned within this disclosure are just an example, and that the VCE may support multiple languages, including code in which different parts are written in different languages. The VCE may also support non-language application definition models (such as JSON or XML-based definitions) or mixed models (such as React's JSX). The VCE may perform this matching based on the injection of metadata into the edited code. This is in addition to any metering, profiling, error handling, error framing, and other code injected into the developer's original code.

Such metadata (and potentially other injected code) may or may not be visible in the VCE editing environment. The combination of these injected metadata and code may be known as “injected elements.”

It will also be appreciated that the synchronization with changes in the back-end code may be problematic, in the sense that the VCE performs visual changes immediately, and these are sent “back” (to the backend or otherwise) to perform the change in the underlying matched code. Such changes (to the code) can in turn create changes in the display, which may be visually disruptive to the editing process. Even if these changes do not visually change the display component, they could disrupt the editing session in other ways for example, by modifying the cursor position, and focus, highlighting elements, causing flicker or extraneous refresh, or creating other editing disruptions.

The VCE may handle these disruptive effects by including editing session-related information in the injected metadata. Such metadata would return (in the full update cycle) to the editor and allow continuing the editing process without disruption.

It will be appreciated that website code may also be visually represented as a DOM (document object model) or tree (such as an abstract syntax tree (AST)) having a nodes representation of different UI objects or components as described in more detail herein below.

An IDE may receive as input, a partial representation of the code (nodes being skipped or not parsed) without changing the unparsed code or the visual modifications made through editing. The VCE may be initiated with minimal parsing and code injection, and once the UI elements are rendered, only the pertinent elements need to be parsed and handled. This may be handled using a feedback loop to parse only the visible components and/or the needed components (or a subset based on or related to the visible or needed components). This provides fast initiation based on minimal parsing or based on lazy evaluation or predictive evaluation. The feedback loop may involve the continuous interactions of the VCE components, where changes in UI object properties are tracked and updated in both the AST and SimpleAST, and then reflected in the GUI. This cycle ensures that any modifications are synchronized across the VCE display, facilitating a dynamic and responsive development environment. The loop also enables developers to see immediate effects of their code adjustments in the GUI, promoting an efficient and iterative design and coding process.

The VCE may also handle additional components, e.g., based on analysis which indicates additional components which are needed or may be needed by the rendered components or components whose rendering is expected based on the currently rendered subset (e.g., predictive evaluation).

Furthermore, the VCE may similarly implement additional techniques from the realm of lazy evaluation and lossy data representation. This improves performance and saves resources.

As discussed herein above, the VCE may receive incompatible designer code which may produce an error state or get stuck running infinitely. It will be appreciated that most web-based systems are challenged by runtime errors that may have dire consequences (up to a full-screen freeze) on the way the errors are presented. As discussed herein above, the VCE may wrap the code, letting errors be caught during compiling, provide a visual representation of the code showing where errors may be and giving explicit directions for solving the issue, while minimizing the impact on the whole system. This may be done using a feedback loop that lets the designer fix the error immediately, thus allowing debugging of incomplete code while writing it.

The VCE may further integrate error notification, handling, and integration into the displayed application UI, so that the user's interaction is limited to a specific part of the screen while other parts of the application/displayed UI continue functioning in other areas of the screen.

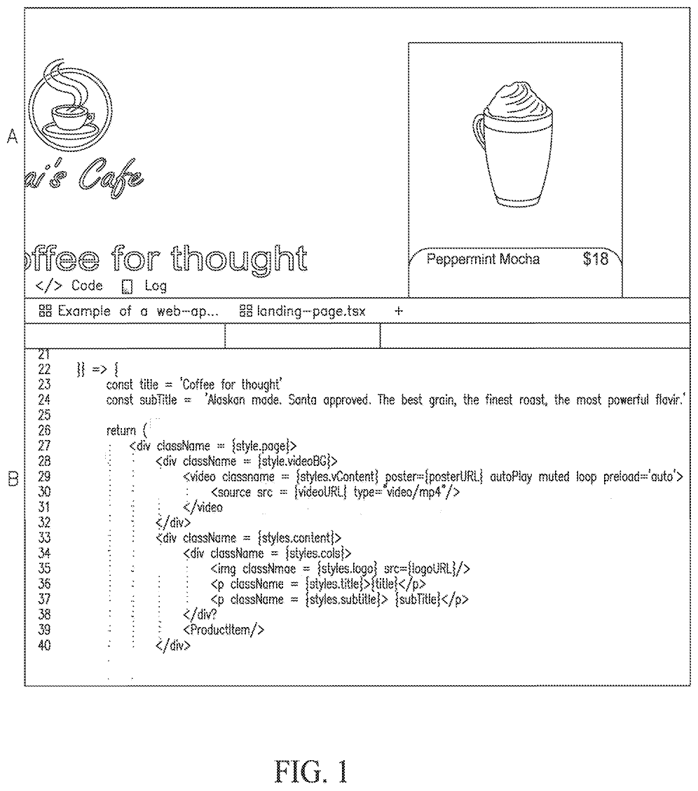

Reference is now made to FIG. 1 which illustrates a VCE UI showing panels for both visual editing display (A) and code editing display (B).

The VCE may run user code, showing its visual output of it, and allow editing of the code using visual controls. The updated code is then rerun to show the updated output. This is all done while the system is running.

The VCE may further log code and associated runtime information as described herein above as well as integrate external code and transform it by wrapping code into an intermediary representation to isolate individual components. This may prevent runtime errors during compilation.

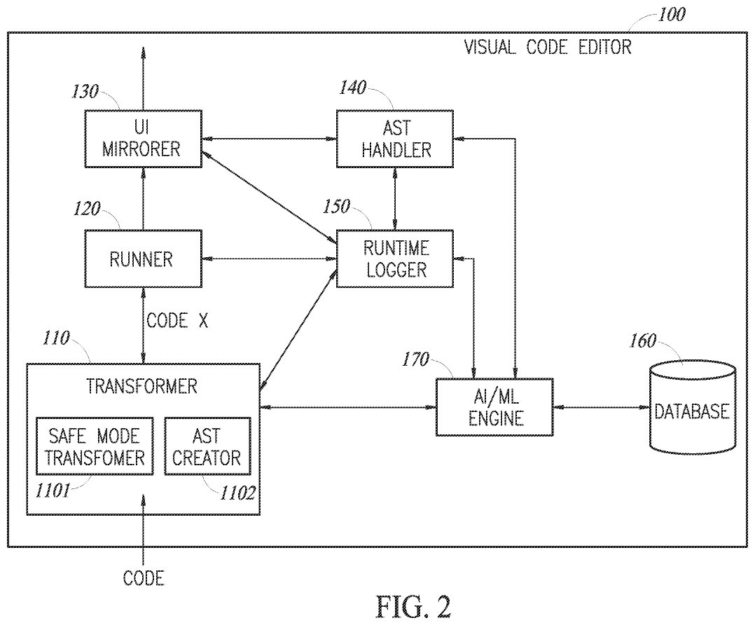

Reference is now made to FIG. 2 which illustrates a VCE 100 according to an embodiment of the present invention. VCE 100 may comprise a transformer 110, a runner 120, a user interface (UI) mirrorer 130, an Abstract Syntax Tree (AST) handler 140, a runtime logger 150, a database 160 and an artificial intelligence (AI)/machine learning (ML engine) 170. Transformer 110 may further comprise a safemode transformer 1101 and an AST creator 1102. Database 160 may be used to store pre-defined components that may be used to create a website, the output of runtime logger 150 and designer specific editing history that may be recorded for the designer while he is using VCE 100. The functionality of these elements is described in more detail herein below.

It will be appreciated that VCE 100 may be an IDE implemented and that the functionality of the elements of VCE 100 may be framework agnostic through the use of plug-ins (such as plug-ins handling specific frameworks).

VCE 100 may also be considered a visual editing tool for front-end code projects. The front-end code (once transformed) may consist of many nested components built in a tree-like structure and allow VCE 100 designers to edit them. For the designer to edit the components, the code first needs to be rendered. It will be appreciated error rendering may propagate up the tree and cause the entire code structure to result in an error and show nothing on the pertinent GUI. Therefore VCE 100 may comprise a safe mode as an effective editing solution to localize the errors, stop the error propagation, and allow designers to potentially fix any errors.

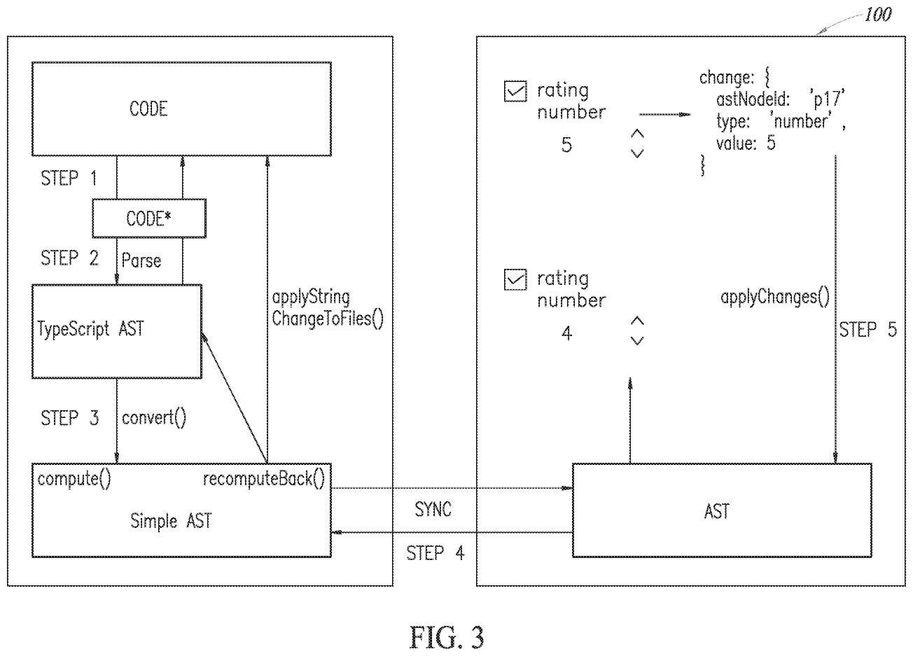

Reference is now made to FIG. 3 which shows the flow of functionality for VCE 100. As is illustrated, user or designer generated code (such as Typescript) is parsed into a safemode catch version code * (transformed code) (step 1) which is further transformed into its AST version (step 2). It will be appreciated that an AST version of the code is required in order to display any errors that may be visually caught as described in more detail herein below. The AST representation is further converted to a simplified AST version (step 4). Editing changes to the simplified AST version of the code are synchronized back to the full AST version (step 4) which in turn updates the code (step 5).

VCE 100 may receive incoming code. This may be any kind of code that is to be used to create a web-related output such as an example C++, C, Java, Javascript, Typescript as well as other languages that may create an output for web clients such as HTML, CSS, Javascript, etc.

It will be appreciated that VCE 100 may also handle code and NoCode infrastructures, such as JSON files, and have different permissions to the ones editing the code from the ones editing the NoCode.

Transformer 110 may create a new wrapped version of the code (code * or transformed code) with adaptations to help runner 120 create the data structures and code needed for UI mirror 130. There may be several kinds of transformations including safe mode as described in more detail below. The transformed code may include the original code with or without transformations, additions, replacements, links to other files, new comments, and a new code change. Safemode transformer 1101 may also add safe mode capabilities to capture errors during rendering and to prevent error propagation by catching syntax and specific wrapping code. This is to enable designers to fix the errors. AST creator 1102 may further create an AST version of the code to be used for catching any code errors and for editing as described in detail herein below.

As discussed herein above, VCE 100 may operate a safe mode, the ability to maintain the coupling of code and design even if the code is (temporarily) broken. Broken code is isolated/turned off during rendering and the GUI will still display correctly (apart from the broken feature).

Safemode transformer 1101 may wrap the initial user code in order to localize errors in a front-end application. Wrapping of code (with another code) is known in the art and is performed on specific elements (such as UI elements) and at specific places in the code such as adding a try/catch command. Therefore, at runtime, a visual representation of any error found can be provided to the GUI of the application.

Safemode transformer 1101 may provide (as an example) JSX (JavaScript xml) expression transformation by wrapping the user code with a call to the Runtime.safeExecuteExpression which ensures that wrapped code does not crash by catching the event and handling it. Every JSX node is also transformed so that it is created by a call to runtime.createElement (instead of React.createElement).

For example:

### Code Before Transformation:

<input value={zrops.title}>

### Code After Transformation:

<input value={runtime.safeExecuteExpression(( )=>zrops.title, {lineNumber:3, char:18})}>

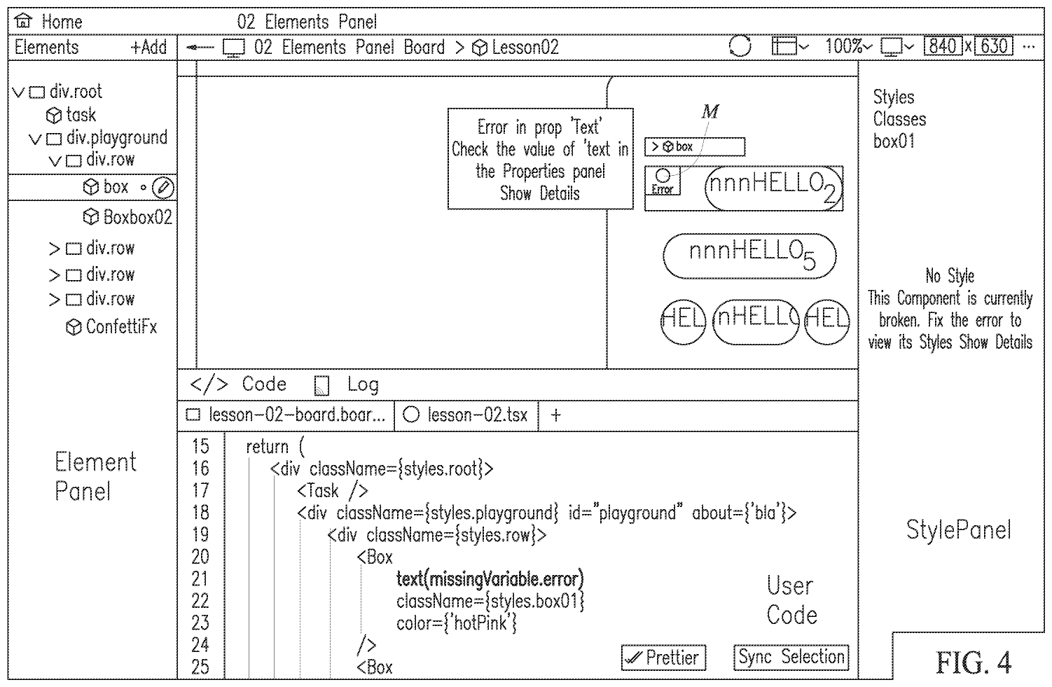

In this scenario, the Runtime.safeExecuteExpression runs the user expression immediately, returning the value if no error has occurred or returning an error symbol containing the original error message and code location of the expression. When runtime.createElement is called with the parent node, it checks the properties of the newly created node for the error symbol. If any are found at runtime, createElement replaces the node with an error warning component showing the error as is illustrated in FIG. 4 to which reference is now made. FIG. 4 illustrates an example of a page display in both its code and visual formats. As is shown, the page displays normally apart from component M and the designer receives a prompt to check its properties as is shown by the bolded code in line 21.

Safemode transformer 1101 may also provide component logic transformation by wrapping the entire function body with a try-catch statement. If an error occurs, an error component is displayed showing the error information. For example:

### Code Before Transformation:

(props )=>{
Const [value, updateValue] = useState(zrops.title)
return <form>
<h3>Title</h3>
<input value={value}/>
</form>
}

Code after Transformation:

```
  (props )=>{
  try{
  Const [value, updateValue] = useState(zrops.title)
  return <form>
  <h3>Title</h3>
  <input value={value}/>
  </form>
catch(err){
  return <ErrorComponent message={err}/>
  }
```

Safemode transformer 1101 may also provide component boundaries transformation by wrapping the user code with an error boundary component. Therefore, if the wrapped component throws an error, the broken component displays the error information. For example:

### Code Before Transformation:

(props )=>{
return <div>
<Component/>
</div>
}

Code after Transformation:

(props )=>{
return <div>
<ErrorBoundry>
<Component/>
</ErrorBoundry>
</div>

It will be appreciated that Safemode transformer 1101 may also protect against infinite code running. Some user code may be very slow and result slow or even result in infinite processing. In these cases, VCE 100 may block the user code running, throwing an error that is caught by error-catching mechanisms such as those described herein above. Another mechanism may be a simple timer-based solution, where a global variable is set to null every millisecond if the thread running the user code is idle. In this scenario, the user code is transformed to have many calls to a method that sets the global variable to the current time if it is null and if it is not null, compares the time passed, throwing an error if a pre-determined amount of time has passed.

Safemode transformer 1101 may also provide protection against infinite rendering. In this scenario, it may protect against cases where a component returns an instance of itself (can be a larger loop), resulting in infinite rendering. The runtime is called with the component source location and blocks rendering when a maximum depth (of the same component) is reached. If this maximum is reached an error component is returned instead of the component view. For example:

### Code Before Transformation:

Const MyComp = (props )=>{
return <div>
<Component/>
</div>
}

Code after Transformation:

Const MyComp = (props )=>{
if(runtime.maxDepthReached({ lineNumber: 3, char: 3}){
Return <ErrorComponent msg='maximum depth reached for MyComp”/>
}
return <div>
<Component/>
</div>

Safemode transformer 1101 may also provide protection against infinite loops by adding calls to the runtime.createLoopCounter and calls to the counter. When the loop limit is reached. An error message is displayed. For example:

### Code Before Transformation:

Const MyComp = (props )=>{
while(true){
doSomething( );
}
return <div>
<Component/>
</div>
}

### Code After Transformation

Const MyComp = (props )=>{
Const loopCounter = runtime.createLoopCounter({lineNumber: 3, char: 3});
while(true){
loopCounter( );
doSomething( );
}
return <div>
<Component/>
</div>
}

Safemode transformer 1101 may also provide protection against infinite recursion by duplicating the JS execution stack. For example:

### Code Before Transformation:

Const a = ( )=>{
Return b( );
}
Const b = ( )=>{
Return a( );
}

### Code After Transformation

Const a = ( )=>{
Const wrapReturn = runtime.methodCalled({ lineNumber:3, char:3 });
Return wrapReturn(b( ));
}
Const b = ( )=>{
Const wrapReturn = runtime.methodCalled({ lineNumber:8, char:3 });
Return wrapReturn(a( ));

The “methodCalled” method pushes the method information into a global stack, and wrapReturn pops the item from the stack. If the stack is longer than the max-recursion-limit the “methodCalled” method throws an error. If the stack has more instances of the current function location than the max-method-recursion-limit, the “methodCalled” method throws an error.

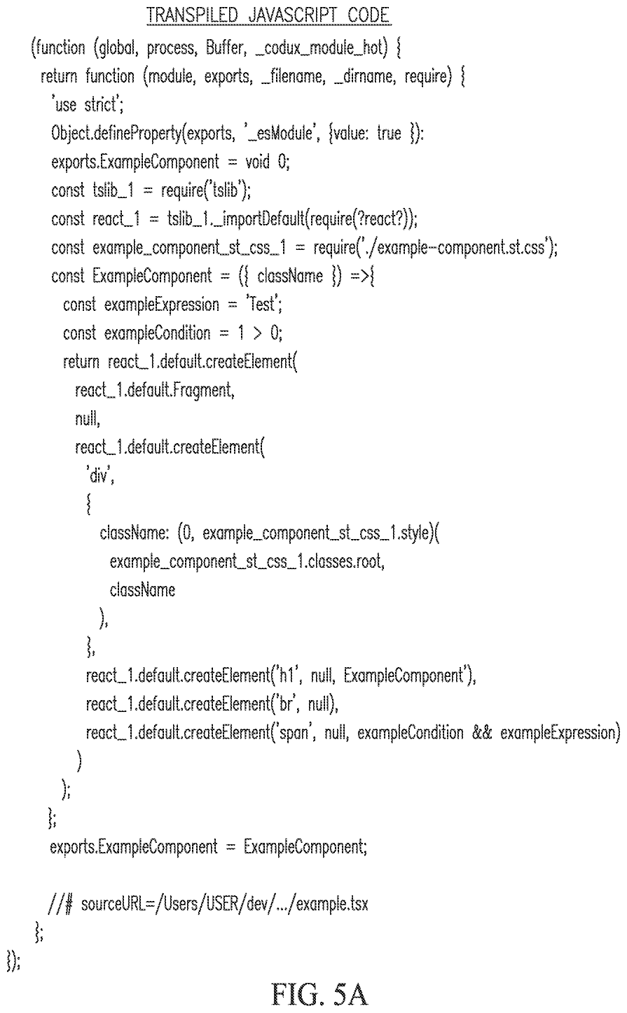

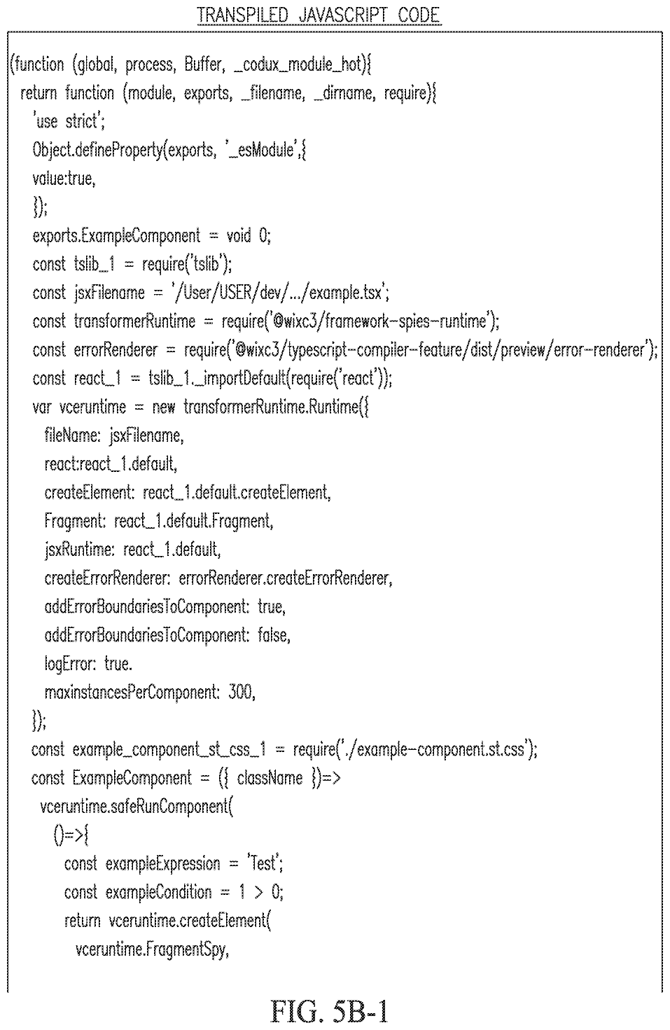

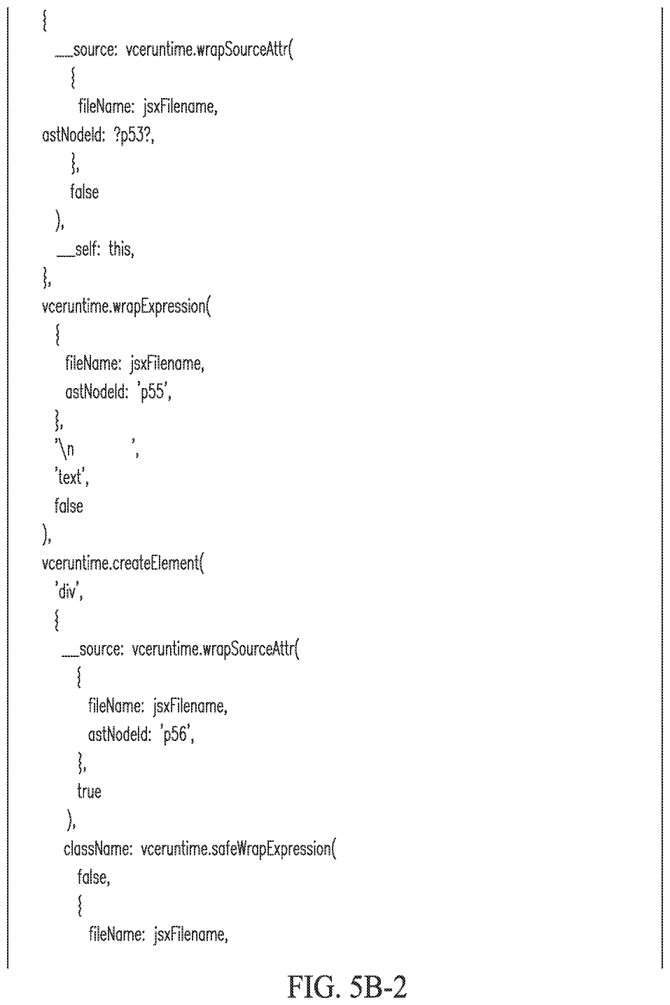

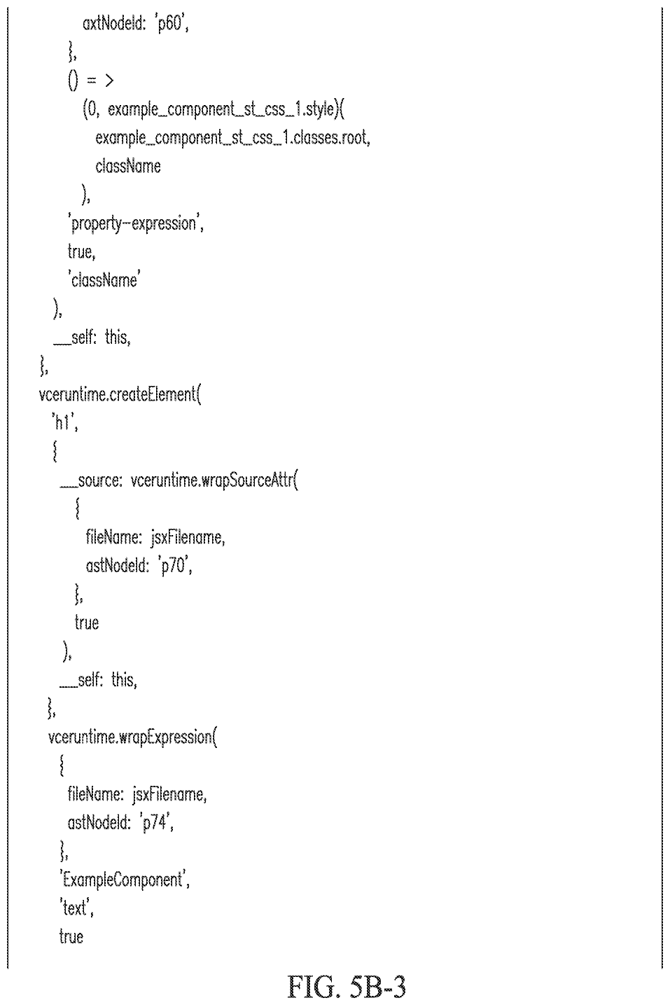

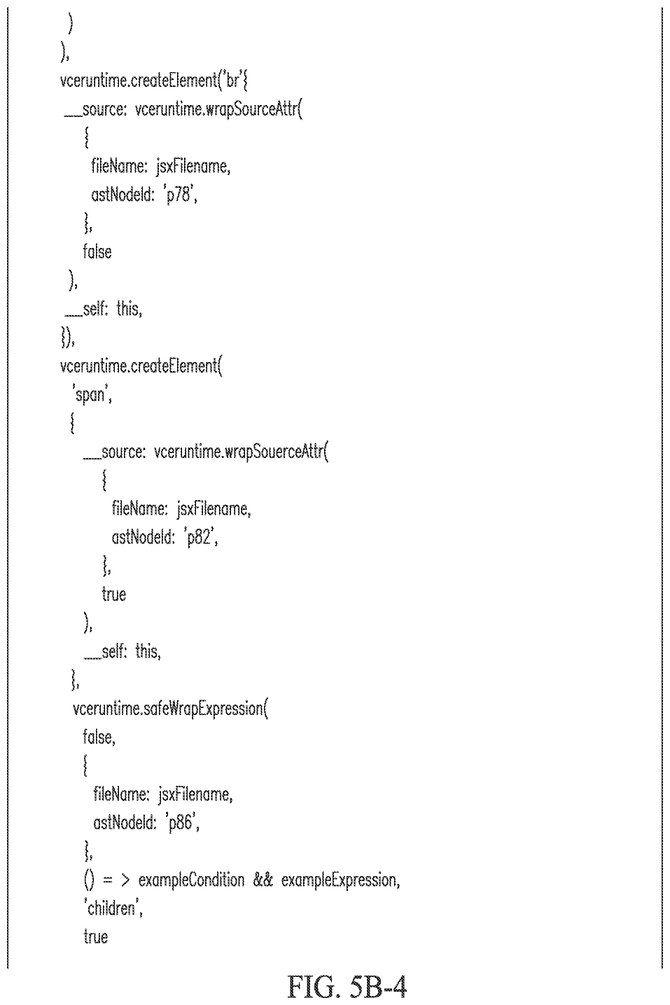

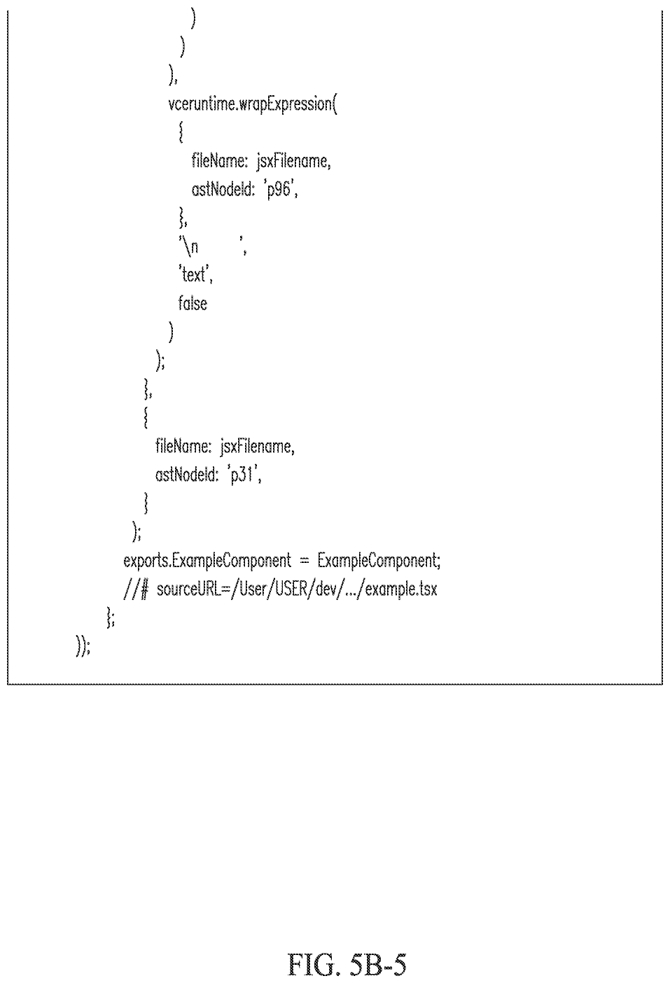

As discussed herein above, part of the transformation by transformer 110 is the injection of metadata into the compilations phase between the user code and transformed code * (for example Typescript and Javascript). Reference is made to FIGS. 5A and 5B1-5 which show illustrative example code of how this is implemented. FIG. 5A shows an example of compiled JavaScript code when no changes are made by transformer 110. FIG. 5B shows an example of compiled JavaScript code. Transformer 110 may identify relevant nodes and add the “_source” attribute for further marking. It will be appreciated that in this example vceruntime is a placeholder and may be changed.

AST creator 1102 may transform the transformed code * or in an alternative embodiment non transformed code into a language specific AST representation. It may use a propriety language specific plug-in which may create the representation which may be then changed, adapted, and updated as the result of editing sessions as described in more detail herein below. The generated AST code may be displayed by UI mirrorer 130 for the designer to check his transformed code i.e. to catch any “breaks” created by safemode transformer 1101. In this scenario, UI mirrorer 130 may adjust the display by modifying the cursor position, highlighting elements, causing flicker or extraneous refresh, or creating other editing disruptions. The generated AST code may be further converted to a simplified AST representation by AST handler 140 for visual editing as described in more detail herein below.

AST creator 1102 may designate a unique ID to every node. It will be appreciated that over the course of using VCE 100 (such as editing the code's position, path, etc.), the AST trees get modified/deleted/updated and need to be compared to other AST trees to ascertain the differences in order to present a single synchronized presentation to the designer with full synchronization to the code as described in more detail herein below.

Runner 120 may compile, run, and render the AST code, and send it to UI mirrorer 130 for display.

UI mirrorer 130 may simulate the presentation layer for runner 120 i.e., provide the visual representation for editing. The presentation layer may be the visual display, or the code display as shown in FIG. 1 back to which reference is now made. In another embodiment, the display may also be browser or other kind of presentation layer.

UI mirrorer 130 may be based on a JS engine (such as V8) that runs in concert with a rendering engine such as Blink to create a DOM tree representation of the code. It will be appreciated that the DOM tree is created for presenting the UI while the AST representation is created for internal data manipulation and code representation for use by AST handler 140 as described in more detail herein below.

It will be appreciated that the input to UI mirrorer 130 may be files or part of files, created by runner 120. UI mirrorer 130 may then utilize a set of software hooks and application programming interfaces (APIs) to control the way code * is presented to get a preview exactly as if it was running on a real browser. The main difference from a real browser is that actual browser rendering does not take place. Thus, a designer may have full control on the way the DOM is built, and the properties windows are created, which may be interleaved with the different GUI elements. Runner 120 may similarly use hooks or APIs.

The actual UI may be browser based or based on other UI rendering engines on different platforms. This may be done using iFrame or any other technology which shows the UI of the currently running code.

As discussed herein above, when presenting the UI, UI mirrorer 130 may use plug-ins to be able to support different UI platforms, such as Mobile, 3D, and others. UI mirrorer 130 may also use frameworks such as React and the React Devtools (available from react.dev), or a different framework. This may be done using iFrame or other technologies which show the UI of the currently running code (such as Android WebView).

It will be appreciated that a designer may interact with the running program by sending inputs and updates to UI mirrorer 130 via AST handler 140 as described in more detail herein below.

AST handler 140 may handle the visual representation of code by converting the AST representation to SimpleAST. SimpleAST is known in the art as a simplified version of the AST representation. It aims to provide a more straightforward and human-readable representation of the code structure. It will be appreciated that SimpleAST may be language agnostic (and may allow code editing via the GUI without requiring implementation details such as AST/original code/language.

AST handler 140 may also handle edits to the displayed SimpleAST structure including handling real time updates to the actual code as described in more detail herein below.

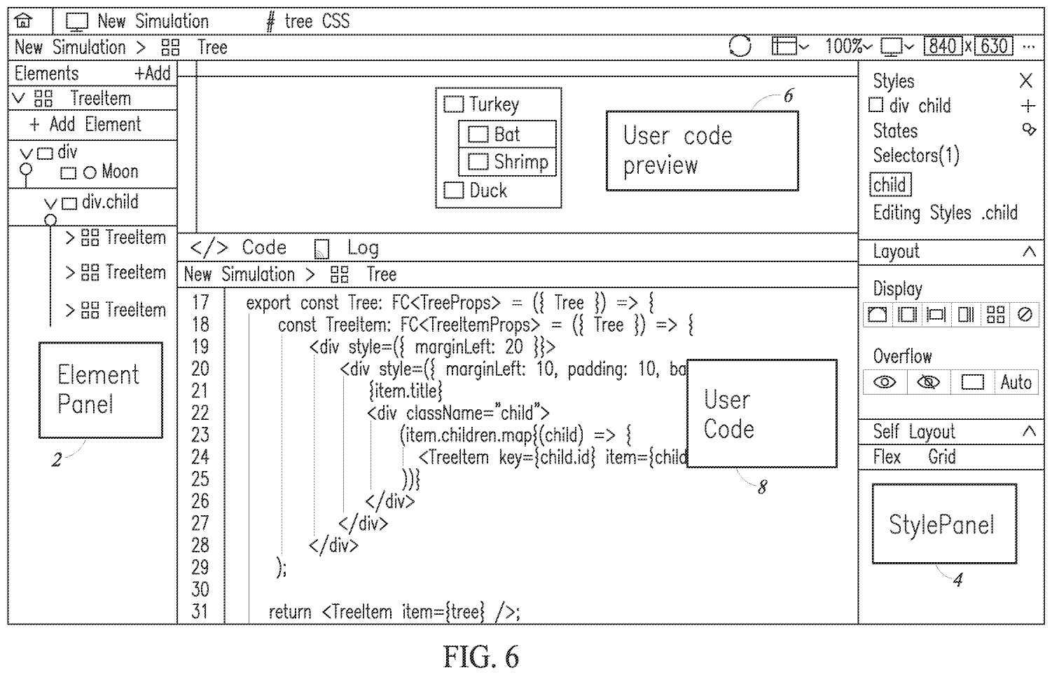

Reference is now made to FIG. 6 which illustrates an example GUI. FIG. 6 shows the elements panel 2, the style panel 4, the user code preview 6 and the user code 8.

Elements panel 2 may implement a tree model that is created from information from AST handler 140 on the edited component. It is then expanded with relevant component properties. Then it is expanded again, adding information from runtime logger 150 spying on the user code when running, through different services. For example, an HTML based component tree may gather information from the component code and the component HTML structure derived from the structure rendered in the GUI such as from a browser. The designer may use elements panel 2 to see the visual representation of the components and use it to make edits such as adding, deleting, moving components etc.

It will be appreciated that nodes may be presented as multiplied not only because UI mirrorer 130 knows that they have been rendered several times (based on the analysis knowledge of the runtime/preview code from runtime logger 150 as described in more detail herein below), but because AST handler 140 may derive its data model from the static display as described in more detail herein below.

Style panel 4 may present the styles of the current UI elements. The styles may be edited, and any edits are shown immediately in the GUI and propagated to the code using AST handler 140 as described in more detail herein below. Style panel 4 may determine what CSS rules are currently being used by a component rendered in the user code preview 6, where they are defined in the user code preview 6 and what the computed values of expressions are in the CSS.

It then enriches the information of each rule with information from the SimpleAST of the file (as determined by AST handler 140) as defined in the editable version of the SimpleAST representing each rule. The CSS rule, as displayed on screen, is defined by code in a CSS that is analyzed and has an AST and SimpleAST representation.

User code 8 represents the code version of the display in user code preview 6 and which may be updated during visual editing of the user code preview 6 as described in more detail herein below.

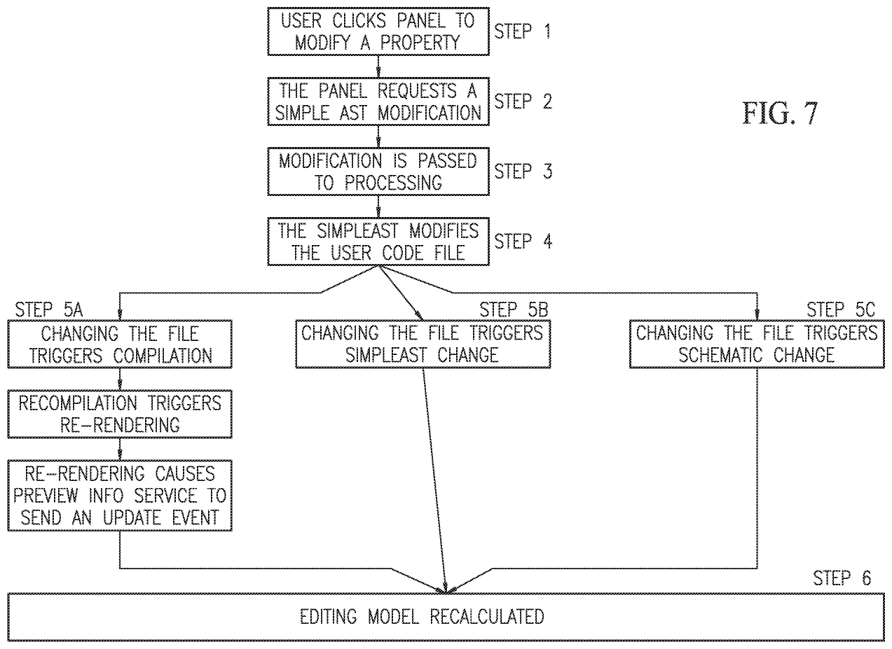

Reference is now made to FIG. 7 which illustrates the flow of use of the style panel. As can be seen, the designer clicks on the panel (step 1) and the panel requests a SimpleAST representation from AST handler 140 (step 2). The modification is made (step 3) and AST handler 140 modifies the code file (step 4). The modification either triggers a new file compilation (step 5a), a SimpleAST change (step 5b) or a schematic change (step 5C). The editing model is then recalculated accordingly (step 6).

As discussed herein above, the user code is the raw user code (such as Typescript) or definition files (such as JSON used in NoCode settings).

The user code preview 6 may be implemented using iFrame (or other technologies as noted above), or by any other technology/window which shows the UI of the currently running code. This preview panel is the reflection of UI mirrorer 130.

Therefore, any code can be used that creates a web-related application. Raw (typescript) code is “transformed,” individual modules representing different components are identified and when run, safety measures are put into place to isolate errors without breaking the full code.

In one embodiment, runner 120 and UI mirrorer 130 may be implemented as part of a renderer. In an alternative embodiment, they may also be implemented as part of a browser or as an iFrame with a private renderer.

As discussed herein above, AST is the main data model which is used throughout all the components to provide the visual data model. The AST representation may be further manipulated using AST handler 140 which may abstract the AST into SimpleAST which is a middleware language designed to allow for simplifying the development of manipulation tools with specific purposes. The format is a lossy format, selectively preserving or ignoring pieces of user code and allowing different kinds of manipulation. Supported languages include but are not limited to Typescript AST for Javascript/Typescript, PostCSS AST for style sheets and JSON AST. It will be appreciated that AST handler 140 may use a simplified AST with plug-ins to add functionality.

For example, AST handler 140 may convert code to SimpleAST to abstract parts of the incoming code and create a simplified version of the full AST. For example, for a Typescript AST, a positive number in the code may be represented in the AST tree with a node called “NumericLiteral.” A negative number may be represented by a node called “PrefixUnaryExpression” with a parameter of a minusToken, and a child node of “NumericLiteral.” Therefore, while planning editing capabilities for numbers being used in the code, a designer may need to create a simple mapping to allow for editing numbers with a single input which allows for both positive and negative numbers.

It will be appreciated that with the simplified AST infrastructure, both negative and positive numbers in the code may be mapped into a single node (i.e., NumberNode) and allow modifications.

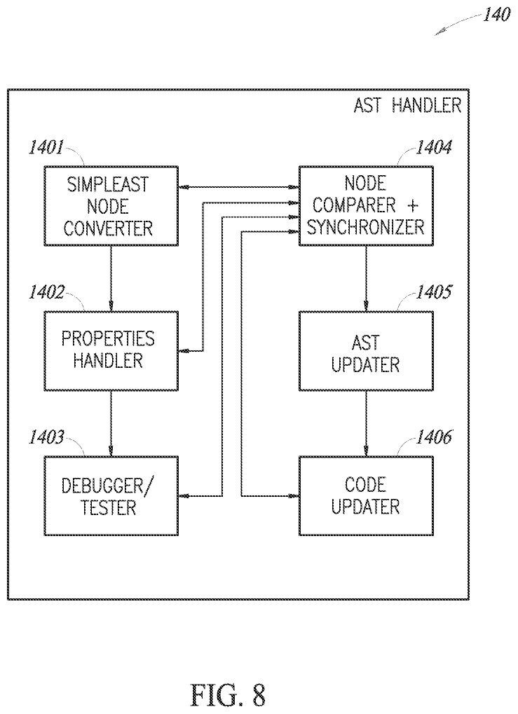

Reference is now made to FIG. 8 which illustrates the elements of AST handler 140. AST handler 140 may comprise a SimpleAST node converter 1401, a properties handler 1402, a debugger/tester 1403, a node comparer and synchronizer 1404, an AST updater 1405 and a code updater 1406.

SimpleAST node converter 1401 may convert AST to SimpleAST. It may review the AST and define createBlank, an implementation to generate an empty state of a node (i.e. creating a NumberNode with the value of zero) and getNodeChildren, an implementation to retrieve the child elements (internal pieces of this code) given this specific kind of node (i.e. all element nodes in an ArrayNode). It may also implement replaceChild to replace one of the child elements with another element and implementations for applying modifications. The nodes may be differentiated into different types.

It will be appreciated that SimpleAST node converter 1401 may create an unparsed node, i.e., a node whose content is not relevant to VCE 100. An example can be a React functional component with lots of logic and some JSX returned. In this case, the logic sub-element can be represented as an unparsed node in SimpleAST, however, the return section may be parsed into a tree.

SimpleAST node converter 1401 may also generate SimpleAST node IDs for every node of the specific language AST. They may provide a reference from the Simple AST node to the underlying language specific AST node, allowing the changes to the simple AST nodes to be reflected back to the language specific AST node as described in more detail herein below.

It will be appreciated that different SimpleAST representations may use the same ID for both the AST node representation and the SimpleAST representation. In other embodiments, the same AST node may have different ID representation to its SimpleAST counterpart, based on usage, as defined by the editing panel. For example: <div style={x}/>x may be edited as a property of div, or as a CSS style, depending on the editing context. In this scenario, x is represented as a single AST node that was assigned an AST ID (for example X1) however it can be represented by several SimpleAST nodes (such as property and style) that have the IDs X1.

It will be further appreciated that SimpleAST node IDs are kept the same even after code changes (through a process of comparing the previous underlying AST to the new one after the code change).

Properties handler 1402 may handle changes to component properties of the UI objects which may be reflected in the GUI. Properties handler 1402 may manage and apply changes to the properties of UI objects within an application. When a property of a UI object is modified, either programmatically or through a graphical user interface (GUI), properties handler 1402 ensures that these changes are accurately reflected in the GUI. When properties of UI objects are adjusted and recognized by properties handler 1402, these modifications are also echoed by node comparer and synchronizer 1404 and are reflected in the AST using AST Updater 1405 as updates to the nodes representing the modified UI objects.

Debugger/tester 1403 may record designer interactions with the running program, run scripts of pre-recorded interactions and debug the application using visual hints. This may include catching any safe mode pitfalls as added by safemode transformer 1101.

Node comparer and synchronizer 1404 may keep track of changes during editing using the unique node IDs from the original conversion to AST which may be used to find and handle nodes that may have been added, deleted or moved in the course of editing. This helps in defining the relationship between the different IDs. Node comparer and synchronizer 1404 may start at the root of the tree and compare child nodes of two AST trees of different versions of the same file before and after visual editing or when the matching code is updated by the visual editing. Node comparer and synchronizer 1404 may start by comparing the order and the exact text for each node. If there is a difference, it may instruct SimpleAST node converter 1401 to create a new node or AST updater 1405 to update the node. In the second round, node comparer and synchronizer 1404 may compare trees using text and kind, in a third round it may compare using extracted text, kind, and name, and finally by using just kind.

Node comparer and synchronizer 1404 may ensure that a finalized single synchronized presentation is made to the designer with full synchronization to the code as described herein below in relation to code updater 1406.

AST updater 1405 may implement all modifications performed on the SimpleAST nodes during editing and handle the translation between SimpleAST and AST accordingly.

It will be appreciated that each time a modification is made, the AST representation is recalculated in order to maintain consistency. AST updater 1405 may utilize algorithms, leveraging heuristics and artificial intelligence to ensure that AST IDs are consistently reassigned after external modifications, such as updates through third-party editors or version control systems. Thus, node identity is preserved for relocated code segments, enhancing the system's robustness. It will be appreciated that direct modifications within the graphical user interface (GUI) allow for precise ID preservation due to full change awareness. In scenarios where it is not possible to match IDs after external changes, AST updater 1405 may substitute the affected SimpleAST node with a new one, marginally impacting the user's GUI interaction yet ensuring uninterrupted editing continuity. In this scenario AI/ML engine 170 may make recommendations to assign the same IDs to the same nodes. AI/ML engine 170 may enhance the assignment of consistent IDs to AST nodes post-external modifications by analyzing patterns in code structure and changes over time. AI/ML engine 170 may predict which nodes remain unchanged despite their relocation within the file. Through training on a vast dataset of code modifications typically from the output of runtime logger 150, AI/ML engine 170 may recognize the intrinsic characteristics of code elements, enabling it to reassign the same IDs to nodes that have been moved, thereby preserving the continuity and integrity of the code's structure in the face of external changes. For example: a piece of code that was moved from the top of a file to the end of it should be assigned the same ID. It will be appreciated that if the IDs cannot be matched after external changes are made, the SimpleAST node may be dropped and replaced by a new one. This may provide for a slightly less smooth editing experience in the GUI (since focus in the editing panel may be lost) but the editing may continue without further issues.

It will be further appreciated that when modifications are e made in the GUI, as AST updater 1405 may have knowledge of the changes and accordingly, may preserve the IDs.

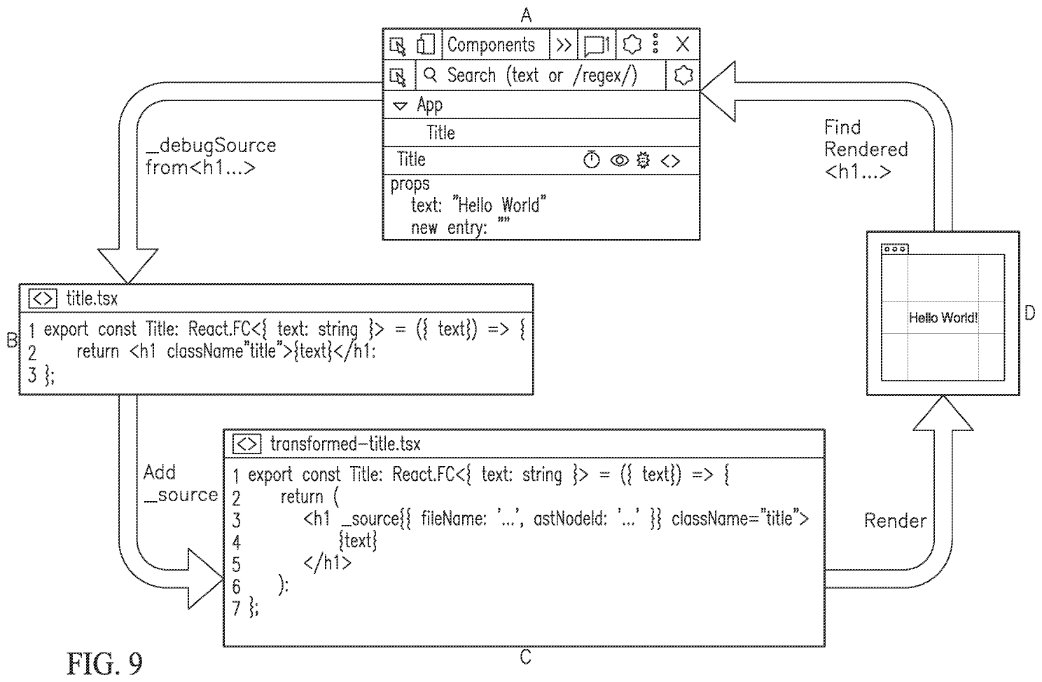

Reference is now made to FIG. 9 which shows an example implementation of an integration cycle or feedback loop showing modifications made to create the visual UI element h1 which in its visual display shows a component with the text “hello world” (right side). The cycle tracks a displayed component (which is the outcome of the display of code which may also be identical for different code files) to the correct source.

Step A shows the editing GUI which allows the designer to edit component properties using simpleAST to display and edit the code. Step B shows the original designer source code before it is processed into SimpleAST by SimpleAST node converter 1401. the code with a modification that allows to track metadata and locate the original. Step C shows the transformed code processed into SimpleAST the code with a modification that allows tracking of metadata and location of original nodes and section D shows the rendered preview which looks exactly like the original code would be rendered but includes additional metadata.

For example, the original code (of a component) is transformed to include a reference to its corresponding ASTNodeID. When the component is rendered, the reference is included in the output (while possibly making such reference invisible to the user). Therefore, when the designer interacts with editable content in the preview, that reference is extracted and used to find the code that generated it. Any editing by the designer is done on the code prior to the transformation. Those changes are re-transformed going back to step A.

Thus, transformer 110 may manipulate Typescript or JS code by adding metadata such as the _source attribute that will add the needed integration metadata such as filename, NodeID. Runner 120 may compile, run, and render the code. UI mirrorer 130 may recognize the metadata of the added h1 tag created by runner 120 and connect it to the specific node of the AST representation and to the specific line in the code using it.

Code updater 1406 may update code according to changes applied to the AST. For example, for the example shown in FIG. 9, it may find the metadata of the added h1 tag and connect it to the specific node and the specific line in the code.

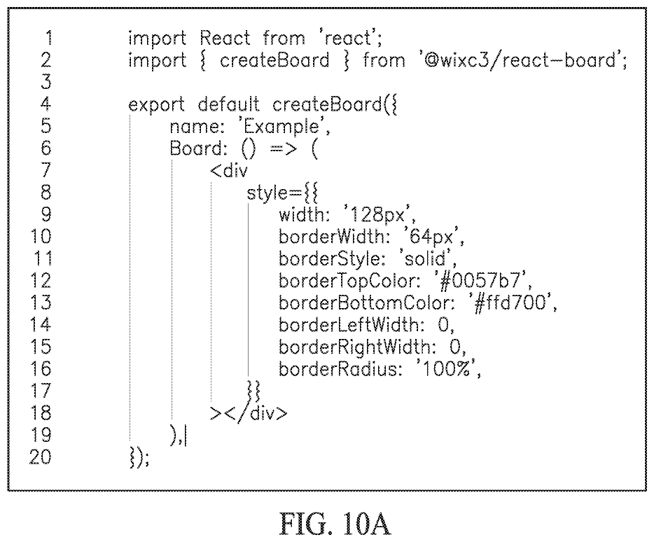

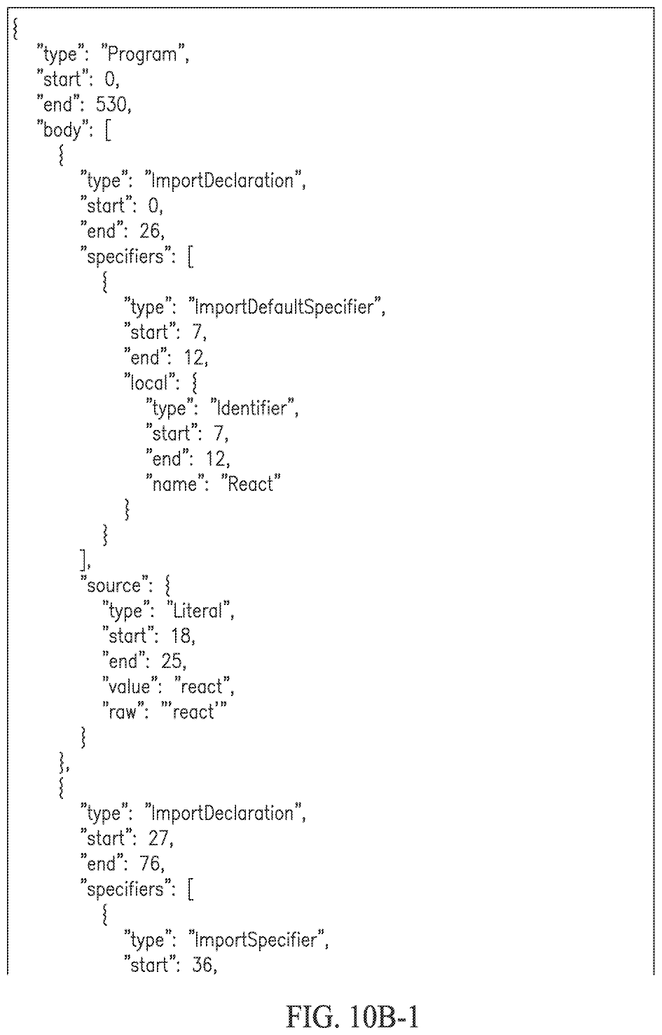

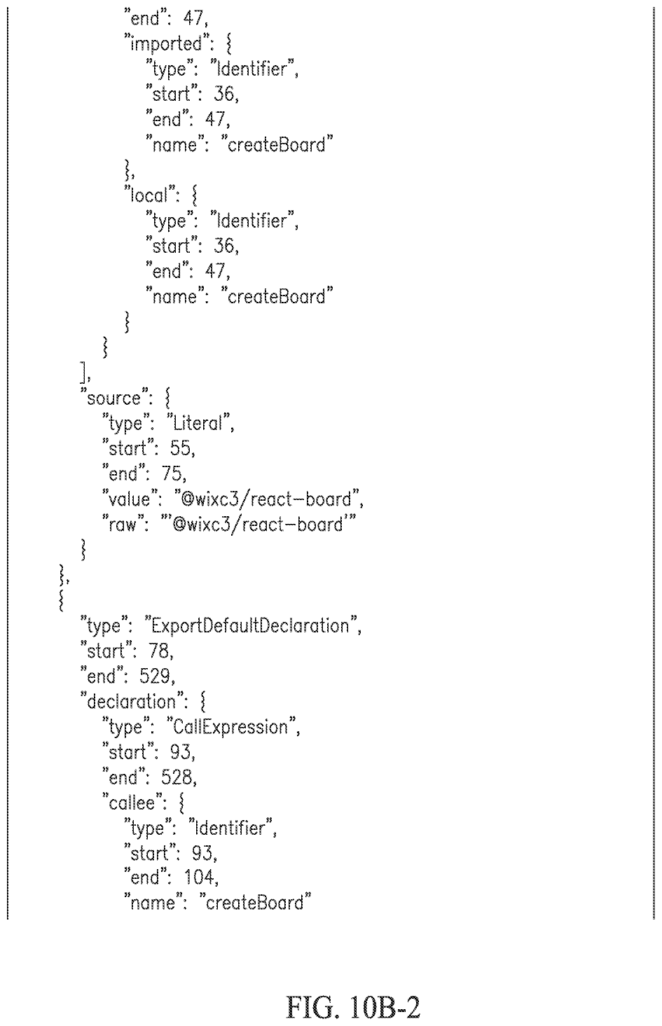

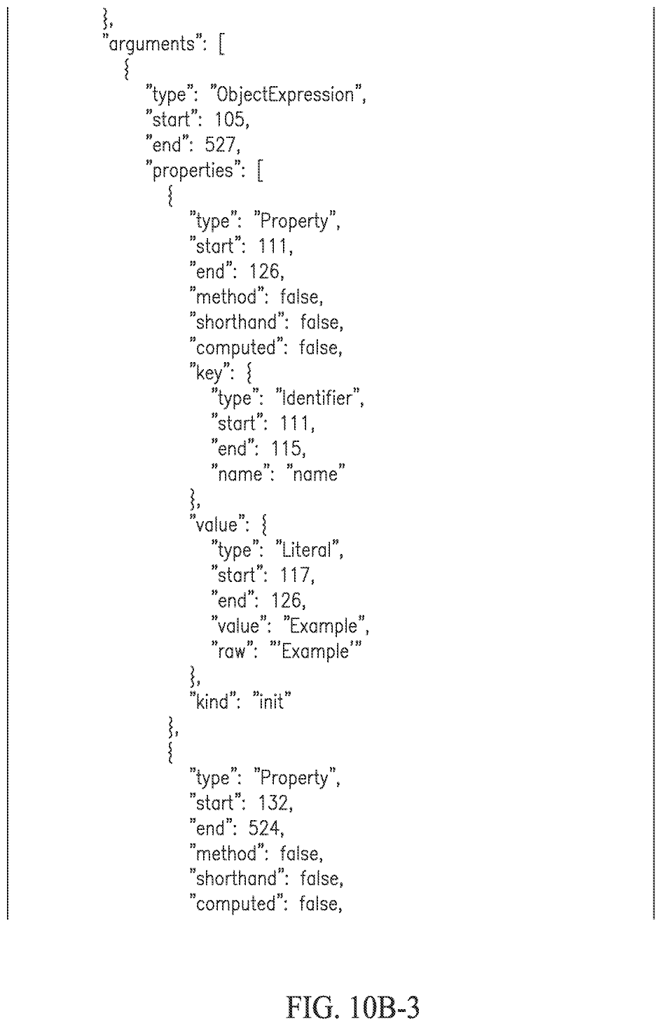

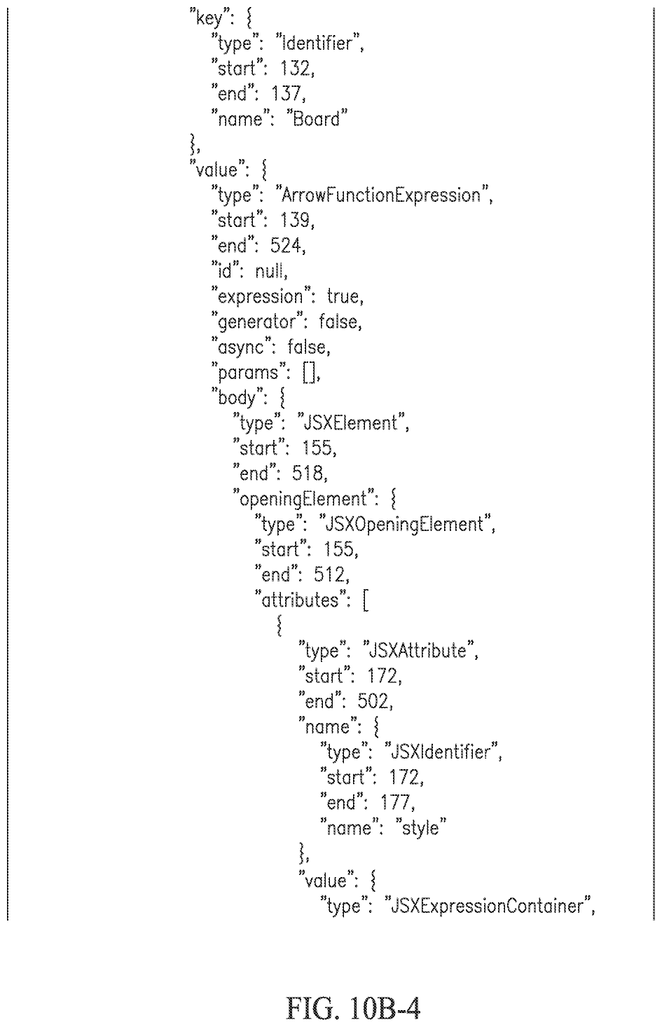

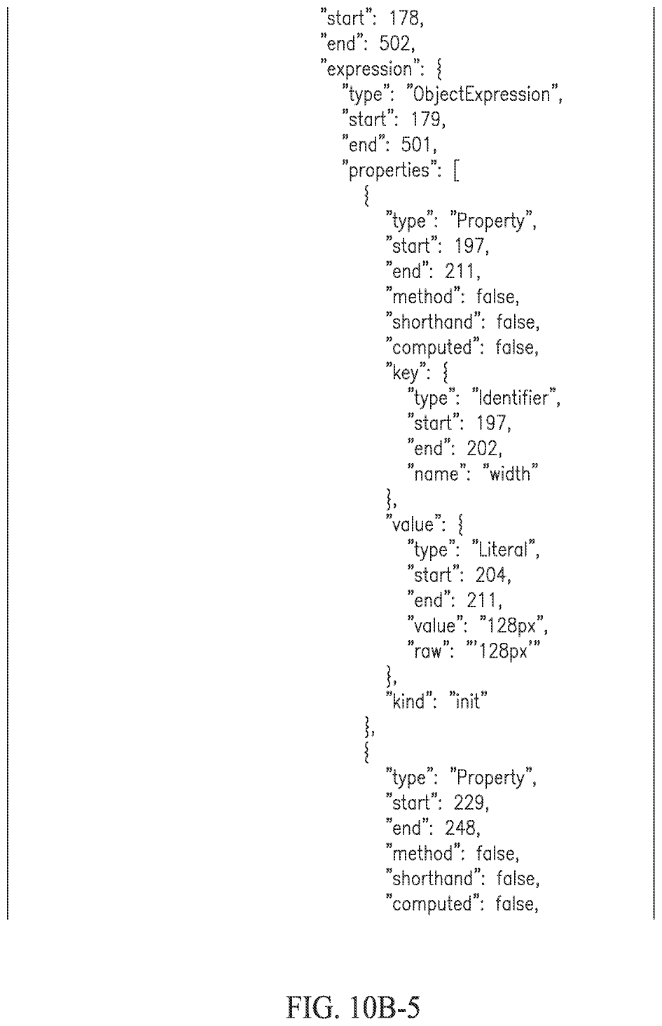

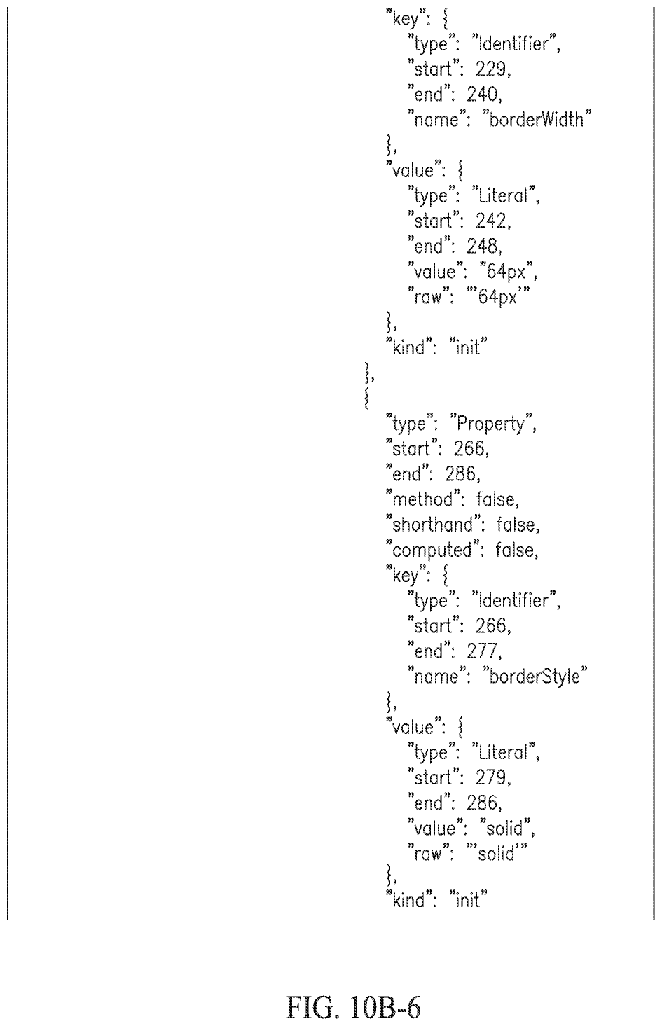

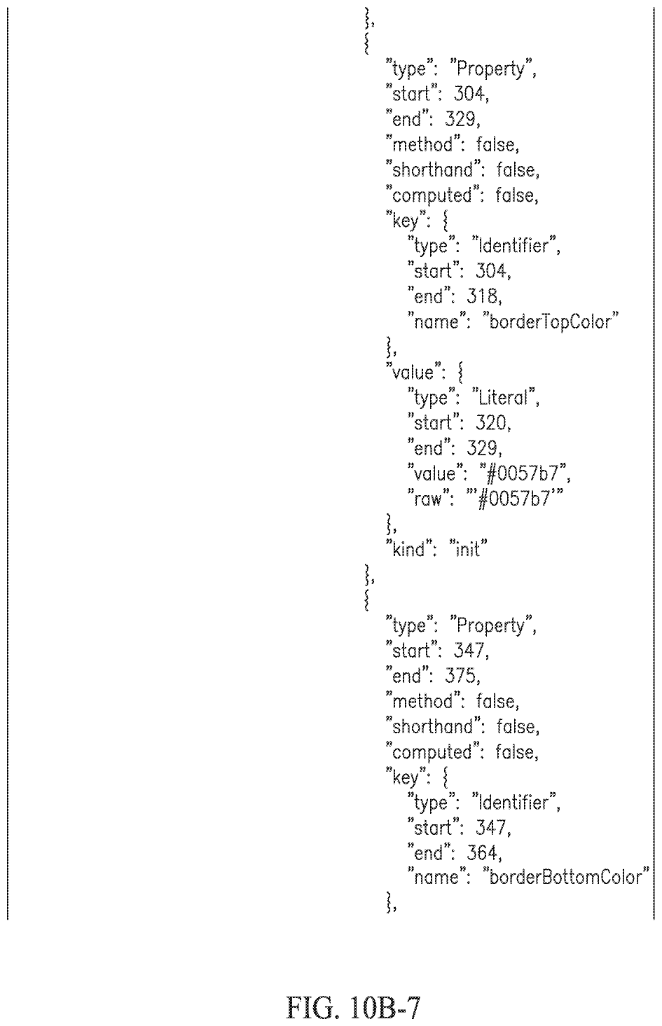

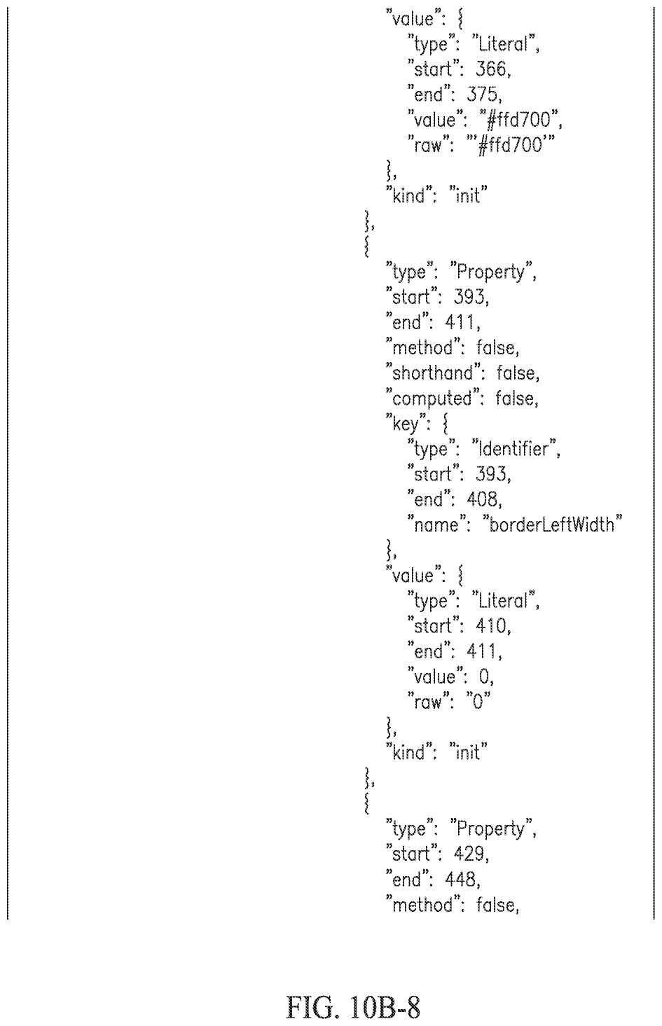

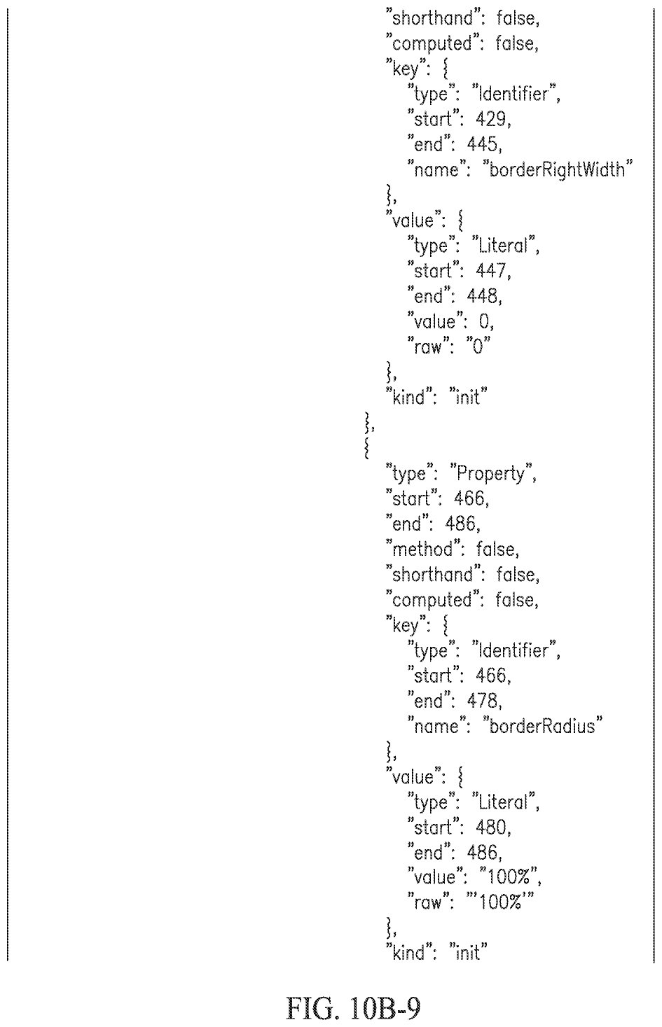

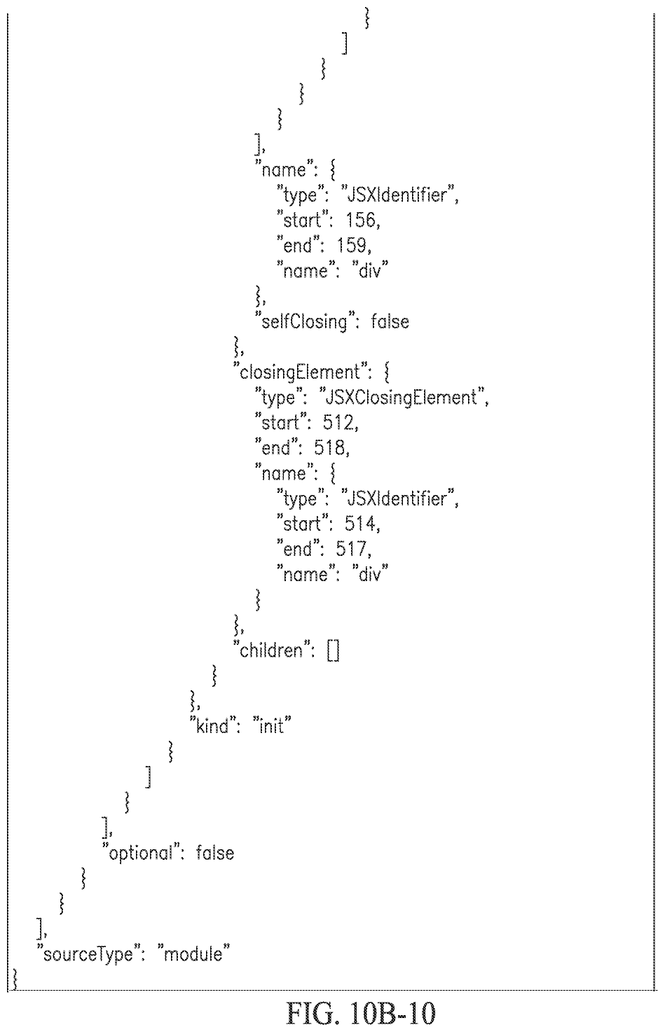

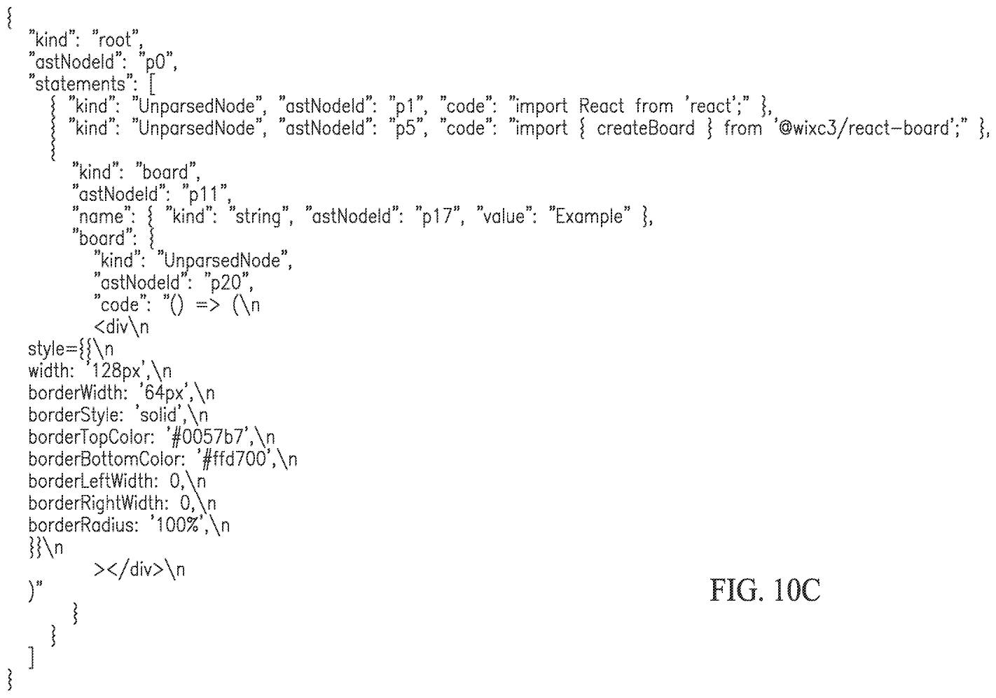

Reference is now made to FIGS. 10A, 10B1-10 and 10C which show example programming code for an example implementation of an integration or feedback loop similar to the example as illustrated in FIG. 9. FIG. 10A shows JavaScript code corresponding to step B that will present a circle with two colors in the UI (this can be considered the equivalent to the display of “hello world” in step D). The first transformation to create an AST file is shown in FIGS. 10B1-10. The transformation from AST to a simplified version of AST shown in FIG. 10C which corresponds to step A as the underlying data structure.

Runtime logger 150 may “spy” on the user code to maintain the connection between the original user code and the transformed code. As discussed herein above, visual elements are created in runtime, and sometimes from a complex code. This kind of code may have complex loops of statements and logic to create a different UI each time the code is run. To enhance the connection between the code and its UI representation while the transformed code is running, runtime logger 150 may gather a log of statistics and values from the runtime phase. These statistics may be the number of times a method was called, the value of specific expressions, a property that was changed, values of component properties, and results of code expressions. The information gathered by runtime logger 150 may be used to improve linkage between the transformed code and its UI representation by providing insights that go beyond simple code execution. For example, if a piece of code dynamically generates UI elements based on user interactions, traditional debugging might not clearly show how or why certain elements appear. Runtime logger 150 may collect data on how often and under what conditions different parts of the code are executed. This can help developers understand why a UI element appears multiple times or changes properties unexpectedly, thereby improving code reliability and UI consistency. The information from runtime logger 150 may be stored in database 160. It will be appreciated that the elements of VCE 100 may use the output of runtime logger 150 to understand how UI elements are built and handled.

As discussed herein above, AI/ML engine 170 may use using artificial intelligence and machine learning techniques and be trained with machine learning models on designer editing history and the output of runtime logger 150 including history of edits to nodes and code.

The terms “trained machine learning model,” “machine learning model,” “model,” or “one or more models” refer to a machine learning or deep learning task or mechanism. Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fitted or trained on a training dataset (e.g., a set of examples used to fit the parameters of the model). The model may be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network). In some embodiments, the model can be trained and/or trained in real-time (e.g., online training) while in use.

The machine learning models, one or more models, trained machine learning models, legitimacy prediction models, improper dispute prediction models, resource volume prediction models, and disputed network transaction prediction models as described above may make use of multiple ML engines, e.g., for analysis, recommendation generating, transformation, and other needs.

AI/ML engine 170 may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by each ML-based engine. Machine learning models are known in the art and are typically some forms of neural network. The term refers to the ability of systems to recognize patterns on the basis of existing algorithms and data sets to provide solution concepts. The more they are trained, the greater knowledge they develop.

The underlying ML models may be learning models (supervised or unsupervised). As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders, transformer-based), models combining planning with other models (e.g., PDDL-based), or Generative models (e.g., GANs, diffusion-based models).

Alternatively, ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks, diffusion-based or auto-encoders) to generate definitions and elements.

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein.

In various embodiments and when appropriate for the particular task, one or more of the ML models may be implemented with rule-based systems, such as an expert system or a hybrid intelligent system that incorporates multiple AI techniques.

A rule-based system is used to store and manipulate knowledge to interpret information in a useful way. It is often used in artificial intelligence applications and research. Rule-based systems constructed using automatic rule inference, such as rule-based machine learning, may be included in this system type. An example rule-based system is a domain-specific expert system that uses rules to make deductions or choices. For example, an expert system might help a doctor choose the correct diagnosis based on a cluster of symptoms, or select tactical moves to play a game. Rule-based systems can be used to perform lexical analysis to compile or interpret computer programs, or in natural language processing. Rule-based programming attempts to derive execution instructions from a starting set of data and rules.

A hybrid intelligent system employs, in parallel, a combination of methods and techniques from artificial intelligence subfields, such as: Neuro-symbolic systems; Neuro-fuzzy systems; Hybrid connectionist-symbolic models; Fuzzy expert systems; Connectionist expert systems; Evolutionary neural networks; Genetic fuzzy systems; Rough fuzzy hybridization; and/or Reinforcement learning with fuzzy, neural, or evolutionary methods as well as symbolic reasoning methods.

An example hybrid is a hierarchical control system in which the lowest, reactive layers are sub-symbolic. The higher layers, having relaxed time constraints, are capable of reasoning from an abstract world model and performing planning. Intelligent systems usually rely on hybrid reasoning processes, which include induction, deduction, abduction and reasoning by analogy.

Therefore, VCE 100 may provide both wrapping of incoming code and a dual display of the code and a visual display of the components. The designer may therefore either fix errors that are flagged in runtime when integrating external code as described herein above or may edit his website either by amending code or by adding/deleting/moving components or by changing their properties.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A visual code editor (VCE), the VCE comprising:
a transformer to receive and transform incoming code to be used for an application being built using said VCE, said transformer to ensure compatibility with other code for said application and to add safe mode wrapping to said incoming code to isolate representation of individual components to localize errors, and to convert said transformed code into an Abstract Syntax Tree (AST) representation having nodes with associated IDs;
a UI mirrorer to display said transformed code together with a visual display of AST representation of said transformed code, wherein said visual display includes a localized representation of errors accordingly;
an AST handler to convert said AST representation into a simplified AST representation for further editing of said visual display; and
wherein said AST handler updates said transformed code according to edits to said visual display and updates said visual display according to edits to said transformed code.

2. The VCE according to claim 1 and further comprising:
a runner to compile, run, and render said AST representation for said visual display by said UI mirrorer;
a runtime logger to gather a log of statistics and values from said runner;
an artificial intelligence (AI)/machine learning (ML) engine to at least analyze output of said runtime logger and designer editing history using artificial intelligence and machine learning techniques to provide recommendations to said AST handler; and
a database to store at least output of said runtime logger and said designer editing history.

3. The VCE according to claim 1 wherein said transformer comprises:
a safemode transformer to add safe mode capabilities to capture said errors and to prevent error propagation during rendering by catching syntax and specific wrapping code; and
an AST creator to create said AST representation of said transformed code for said visual display.

4. The VCE according to claim 3 wherein said safe mode capabilities include prevention of at least one of: infinite rendering, infinite looping and infinite recursion of said transformed code.

5. The VCE according to claim 1 wherein in said UI mirrorer is configured to integrate with plug-ins to support at least one of: mobile and 3D environments.

6. The VCE according to claim 1 wherein said AST handler comprises:
a SimpleASTnode converter to convert the nodes of said AST representation to said simplified AST representation;
a properties handler to handle changes to component properties of components represented by said simplified AST representation;
a debugger/tester to debug said transformed code using presented visual hints;
a node comparer and synchronizer to keep track of edits to said simplified AST representation by monitoring changes to said associated IDs;
an AST updater to update said AST representation according to edits to said simplified AST representation; and
a code updater to update said transformed code according to edits to said simplified AST representation.

7. The VCE according to claim 1 wherein said UI mirrorer presents an interface (UI) comprising at least one of: an element panel, a style panel, the display of said transformed code and a visual representation of said transformed code.

8. The VCE according to claim 1 wherein said UI mirrorer highlights the display of said errors without disrupting an editing session.

9. The VCE according to claim 1 wherein said incoming code is at least one of: Typescript and JSON and said transformed code is JavaScript.

10. A method for a visual code editor (VCE), the method comprising:
receiving incoming code to be used for an application being built using said VCE;
transforming said incoming code to ensure compatibility with other code for said application;
adding safe mode wrapping to isolate representation of individual components of said incoming code to localize errors;
converting said transformed code into an Abstract Syntax Tree (AST) representation having nodes with associated IDs;
displaying said transformed code together with a visual display of AST representation of said transformed code, wherein said visual display includes a localized representation of errors accordingly;
converting said AST representation into a simplified AST representation for further editing of said visual display; and
wherein said converting also updates said transformed code according to edits to said visual display and updates said visual display according to edits to said transformed code.

11. The method according to claim 10 and further comprising:
compiling, running and rendering said AST representation for said visual display by said displaying;
gathering a log of statistics and values from said compiling, running and rendering;
at least analyzing output of said gathering and designer editing history using artificial intelligence and machine learning techniques to provide recommendations for said converting; and
storing in a database at least output of said gathering and said designer editing history.

12. The method according to claim 10 wherein said transforming, adding safe mode wrapping and converting comprises:
adding safe mode capabilities to capture said errors and to prevent error propagation during rendering by catching syntax and specific wrapping code; and
creating said AST representation of said transformed code for said visual display.

13. The method according to claim 12 wherein said safe mode capabilities include prevention of at least one of: infinite rendering, infinite looping and infinite recursion of said transformed code.

14. The method according to claim 10 wherein said displaying is configured to integrate with plug-ins to support at least one of: mobile and 3D environments.

15. The method according to claim 10 wherein said converting said AST representation comprises:
converting the nodes of said AST representation to said simplified AST representation;
handling changes to component properties of components represented by said simplified AST representation;
debugging said transformed code using presented visual hints;
keeping track of edits to said simplified AST representation by monitoring changes to said associated IDs;
updating said AST representation according to edits to said simplified AST representation; and
updating said transformed code according to edits to said simplified AST representation.

16. The method according to claim 10 wherein said displaying presents an interface (UI) comprising at least one of: an element panel, a style panel, the display of said transformed code and a visual representation of said transformed code.

17. The method according to claim 10 wherein said displaying highlights the display of said errors without disrupting an editing session.

18. The method according to claim 10 wherein said incoming code is at least one of: Typescript and JSON and said transformed code is JavaScript.

19. A system for processing code, the system comprising:
a safe mode transformer to wrap said code to facilitate error isolation and debugging;
an AST creator to assign nodes and node IDs to said wrapped code into an intermediary representation;
an AST handler to convert said intermediary representation into a visually editable display; and
an artificial intelligence (AI)/machine learning (ML) engine to assign consistent identifiers to code nodes for said intermediary representation to ensure a stable connection between said wrapped code and said visually editable display.

20. The system according to claim 19 wherein said AL/ML engine utilizes learning models trained on historical code editing patterns to improve accuracy of node identifier assignments over time.
